(19) United States
(12) Patent Application Publication
(10) Pub. No.: US 2023/0204521 A1
(43) Pub. Date: Jun. 29, 2023

(54) METHOD AND DEVICE FOR MULTI-DIMENSIONAL, TOMOGRAPHIC MATERIAL AND/OR CONDITION TESTING AND SENSOR THEREOF

(71) Applicant: Frank Rinn, Heidelberg (DE)

(72) Inventor: Frank Rinn, Heidelberg (DE)

(21) Appl. No.: 18/061,032

(22) Filed: Dec. 2, 2022

(30) Foreign Application Priority Data
Dec. 2, 2021 (EP) 21212025.7

(51) Int. Cl. G01N 22/00

(52) U.S. Cl. CPC G01N 22/00

(57) ABSTRACT

A method for multidimensional, tomographic material and/or condition testing on a test specimen is invented, wherein a sensor with electronics for sending, recording and processing measurement data is arranged in each case on the test specimen or in a region of the test specimen at a plurality of predeterminable positions, wherein at least one sensor or the electronics of at least one sensor is used for carrying out a plurality of different physical measurement methods on the test specimen and for generating, triggering and/or transmitting pulses and/or signals required for carrying out at least one of the measurement methods. Furthermore, a device for multidimensional, tomographic material and/or condition testing on a specimen to assess, in particular for carrying out the above method, is invented, wherein the device comprises a plurality of sensors each having electronics, wherein a sensor with electronics for recording and processing measurement data can be arranged on the test specimen or in a region of the test specimen at a plurality of predeterminable positions in each case, at least one sensor or the electronics of at least one sensor being designed for carrying out a plurality of different physical measurement methods on the test specimen and for generating, triggering and/or emitting pulses and/or signals required for carrying out at least one of the measurement methods. Finally, a corresponding sensor for one such device is disclosed.

### CROSS REFERENCE TO RELATED APPLICATIONS

This application claims priority to and the benefit of European Patent Application No. 21212025.7, filed Dec. 2, 2021; the contents of which as are hereby incorporated by reference in their entirety.

### BACKGROUND

Since the 1960s, the speed of sound (v) in wood poles has been measured along the (wood) fibres and used as a measure of their load-bearing capacity because the dynamic modulus of elasticity (E) was found to be proportional to v² for a known density. Sound (=stress-wave) travel time measurements transverse to the (wood) fibres for damage detection on trees and timbers between a sound transmitter (“impulse hammer”) and a receiver (“sensor”) are known from the 1980s, but they proved to be of little practical use because they were either too inaccurate or much too costly if reliable results were to be obtained. It took several hours or days to measure, analyze and evaluate the cross-section of a tree.

Ultrasonic methods failed at the same time due to the combination of inhomogeneity and anisotropy of the material wood, especially since for the application of the common ultrasonic sensors the bark has to be removed at the measuring point. Therefore, for tomographic condition detection, the bark had to be removed all around, but this inevitably leads to the death of the tree. Therefore, a non-destructive or low-destructive inspection of the cross-section was not possible in this way.

Only after a sonic tomograph consisting of electronically linked and independently measuring sensors was internationally patented (“Arbotom®”: PCT/DE00/01467, May 1999), did this new method become established in practice for determining the presence and extent of (mostly internal) defects: in this system, as many individual and electronically independently evaluating sensors as possible were each placed on a connecting means (nail or screw) going through the bark into the wood and thus firmly connected to the material to assess. The running time of sound pulses between all sensors, which were generated by a manual hammer blow on the same, was measured. The electronically linked sensors thus served as transmitters and receivers at the same time. This made it possible for the first time to determine sufficiently precise and reliable data on the residual load-bearing capacity on the object in a quasi-nondestructive manner and at reasonable cost, but it still typically took 30 minutes or longer per cross section of old trees.

The evaluation of other pulse properties (intensity, decay behavior, frequency, . . . ) proved to be unsuitable because the results varied unsystematically, especially due to the manual pulse generation (by tapping with a hammer). In the end, the runtime of the pulses (=stress waves) proved to be the only one “robust” enough against the difficult and often strongly fluctuating boundary and environmental conditions of the respective measurement (impact intensity, temperature, humidity, coupling strength, . . . ).

The application since then has been on trees and timbers (e.g. glue-laminated beams), as well as on solid building materials such as concrete columns. Although the sensors themselves only detected the transit time of the fastest arriving impulses and thus collected far less information on the impulses and waves than is usual, for example, with ultrasonic techniques, this methodology allowed a fundamentally new and previously unattained quality of condition tomography due to the comparatively high number of support points (=sensors)—whereby the central result when applied to damaged trunk cross-sections is actually only the percentage reduction in the mechanical load-bearing capacity.

In the meantime, this method has become established in specialized circles worldwide. Several thousand corresponding tomographs from various manufacturers are in practical use, mostly at universities, research institutions and by appropriately specialized experts.

A good 20 years of practical application have shown on the one hand the technical possibilities and limitations of this process, but on the other hand also that there would be many more potential areas of application,
if the tomographs were significantly cheaper and the sensors smaller;
if the sensors were not only smaller, but more robust and also waterproof;
if the technical (spatial) resolution of the results were significantly increased;
if the measured values were defined, reproducible and calibratable;
if application and evaluation were faster and simpler and automated as far as possible;
if further material and structural properties could be recorded not only of wood and trees, but also of bells, concrete (and other solid building materials), facade structures, and flood dams.

A new tomograph must therefore be able to do much more than the existing ones and still be much more cost-effective. Simply increasing the number of sensors in the currently established tomographs would not bring any significant progress, but would increase costs and effort accordingly.

### BRIEF SUMMARY

In this respect, therefore, a fundamentally new conception is required—hence the new invention described hereinafter in accordance with the appended claims.

Specifically, a method for multidimensional, tomographic material and/or condition testing on a test specimen is specified, wherein a sensor with electronics for recording and processing measurement data is arranged on the test specimen or in a region of the test specimen at a plurality of predeterminable positions in each case, wherein at least one sensor or the electronics of at least one sensor is used for carrying out several different physical measuring procedures on the test specimen and for generating, triggering and/or emitting pulses and/or signals required for carrying out at least one of the measuring procedures. The sensor can have a housing in which the electronics can be housed in a protected manner. In the sensor according to the invention, not only can intelligent filtering and/or processing of received measurement data take place, but also generation, triggering and/or transmission of the required pulses and/or signals. In a prior art process, for example, it was necessary to generate a mechanical pulse by means of a hammer. This is no longer necessary with the method and device according to the invention.

Depending on the requirements, the pulses or signals can comprise mechanical, electrical, di-electrical, thermal and/or electromagnetic pulses or signals, whereby mechanical pulses or signals can be generated by means of a piezoelectric crystal.

The pulses or signals or a selection of similar or different pulses or signals can be generated, triggered, transmitted, received and/or recorded by the sensor(s) or the electronics in a combined, simultaneous and/or time-coordinated manner. All, i.e. also the mechanical, pulses or signals in all sensors can be generated automatically in a defined manner and thus reproducibly identically in order to enable comparable and for the first time absolute value calibratable analyses.

The pulses or signals or a selection of similar or different pulses or signals can or may be generated automatically in at least one sensor—in a defined manner or by random generator.

Alternatively or in addition thereto, the pulses or signals may be excited, generated, triggered, transmitted, received, stored and/or analyzed by the sensors or the electronics of the sensors themselves in an automated manner and thus without human intervention or activity.

The height, shape, intensity, frequency/waveform and/or time length of the pulses or signals transmitted from can or can be adaptively changed in order to—with regard to an increase in the informative value of the method—to adapt to boundary conditions, disturbance signals and/or material properties of the test specimen and/or to measurement data already recorded or measurement results obtained. Specifically, measurement data recorded by other sensors or measurement results obtained can be used for adaptation in order to increase the informative value of the method.

The adaptation can take place during the course of a measurement and/or automatically adaptively, for example after predefined time intervals.

Furthermore, a decay behavior at one or more sensors can be used, whereby after an excitation, generation, triggering and/or emission of one or more pulses or signals by a sensor or electronics of the sensor, a relaxation at this sensor, at these electronics and/or at a connection means to the test object can be measured and/or recorded.

Furthermore, the pulses or signals can be excited, generated, triggered and/or emitted with a time overlap or time delay in such a way that the total time required for the test or measurement is minimized, or mechanical pulses or signals can be emitted simultaneously or in a resonant manner in order, for example, to be able to better characterize the corresponding material properties.

Electromagnetic pulses or signals can be radiated by means of a directional antenna—preferably miniaturized in terms of construction—at a predetermined angle so that a defined pulse-signal path is achieved through the test specimen.

Alternatively or in addition to this, an arrival of, in particular, electromagnetic pulses or signals can be used as a start signal for the start of pulses or signals from at least one other sensor, in particular also the mechanical pulses or signals.

A display can be implemented on the sensors, the number and/or position of which is displayed as a number and/or letter code and/or as a code or barcode.

Alternatively or in addition to this, the sensors can be connected with a coupling means that allows both a mechanical and an electrical connection, preferably a flat ribbon cable or flat belt can be used as coupling means.

The coupling means can be realized for equidistant connection of the sensors in the form of coupling elements of equal length and/or tensile strength and/or soft flexibility.

The coupling means or the coupling elements can enable an automatic, preferably optical, measurement of the test specimen, its geometry and/or the sensor positions, for example by means of a photograph.

The sensors or boards of the sensors can be provided with—preferably four or six—connecting elements for connecting the coupling means or coupling elements in such a way that a one-, two- or three-dimensional and/or grid-shaped coupled arrangement of the sensors is possible.

Furthermore, in accordance with the invention, a device for multidimensional, tomographic material and/or condition testing on a test specimen is specified, in particular for carrying out a method as described above, wherein the device is permitted with a plurality of sensors each having electronics from, wherein a sensor with electronics for recording and processing measurement data can be arranged on the test specimen or in a region of the test specimen at a plurality of predeterminable positions, at least one sensor or the electronics of at least one sensor being designed for carrying out a plurality of different physical measuring methods on the test specimen and for generating, triggering and/or transmitting pulses and/or signals required for carrying out at least one of the measuring methods.

Furthermore, a sensor of a device as described above is requested.

Important aspects of embodiments of the invention are briefly mentioned below:

Different physical methods are combined in the same sensor, which can be realized as an electronic box.

There can be automated pulse or signal generation.

Reproducible, clearly defined pulses or signals of different intensity, number, length and shape can be generated.

Characteristics of the signals can be adapted to the requirements, test specimen properties and results already achieved during the measurement (instantaneous adaptive signals).

Tension-resistant but transversely flexible connecting cables can be used simultaneously as markers, distance markers or 3D shape encoders.

A quasi-equidistant sensor arrangement can be made, depending on the requirements in 1D arrangement (“belt around tree, concrete pillar, bell), 2D arrangement (mesh on surfaces: facades, flood embankment), or 3D arrangement (built-in concrete).

The new form of tomography described here not only combines several, fundamentally different physical measurement principles, but also combines them in a completely new way, which leads to fundamentally new processes and thus provides a variety of advantages that open up entirely new fields of application and enable significantly more extensive analyses and assessments (than previously conceivable)—at lower costs.

### BRIEF DESCRIPTION OF THE DRAWINGS

There are now various possibilities for designing and further developing the teaching of the present invention in an advantageous manner. For this purpose, reference should be made on the one hand to the subordinate claims and on the other hand to the following explanation of preferred embodiments of the teaching according to the invention with reference to the drawing. In connection with the explanation of the preferred embodiments on the basis of the drawing, generally preferred embodiments and further embodiments of the teaching are also explained. The drawing shows

FIG. 1: an exemplary square sensor board according to various embodiments,

FIG. 2: an exemplary connector configuration according to various embodiments,

FIG. 3: another exemplary connector configuration according to various embodiments, and

FIG. 4: an exemplary illustration with an open outer housing and clamping thereby of the cable upon closure.

### DETAILED DESCRIPTION OF VARIOUS EMBODIMENTS

Detailed description of embodiment examples:

Miniaturization

By integrating as many as possible of the electronic tasks to be performed in the sensors into an application-specific circuit, not only are the dimensions reduced but, given sufficient production numbers, the unit costs also drop considerably, so that the significantly less expensive electronics can be accommodated in a smaller and equally correspondingly less expensive housing. This means that the number of tomography sensors can be increased significantly without increasing overall manufacturing costs, which not only makes the evaluations more accurate and reliable, but also opens up entirely new fields of application. For example, it has been shown that statically dangerous cavities in flood dams can be found and localized with time-of-flight sound measurements—but only if a very large number of sensors are arranged in as tight and regular a grid as possible on the curved surface. This was not possible with the previously available techniques in practical applications.

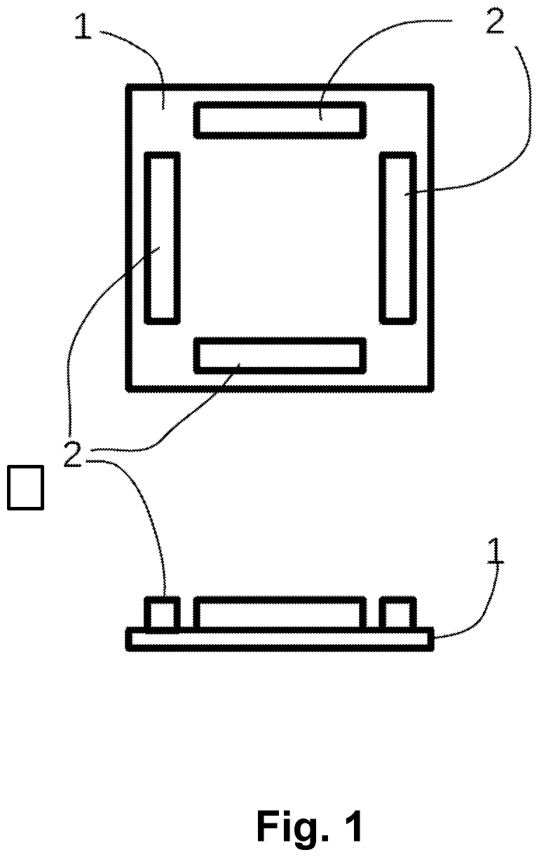

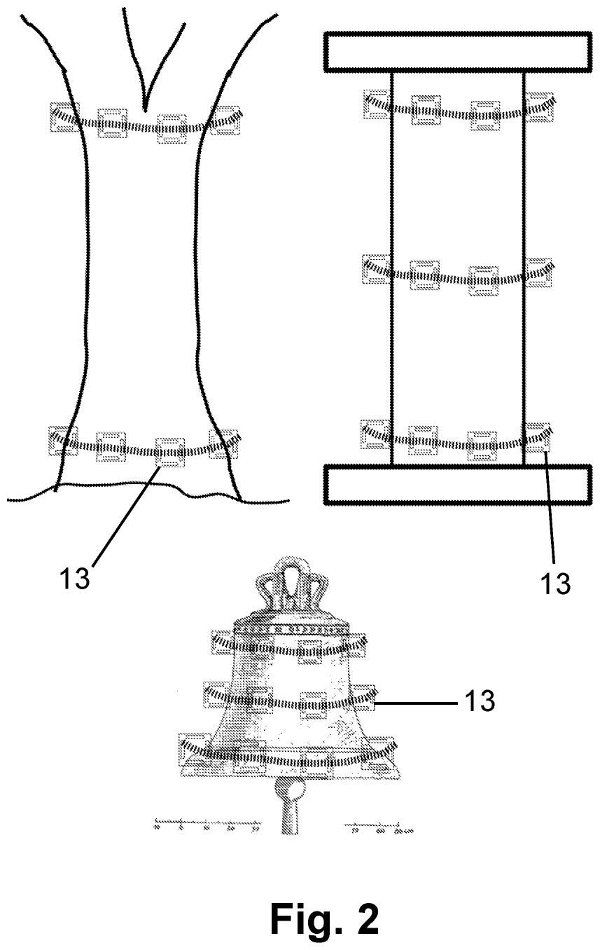

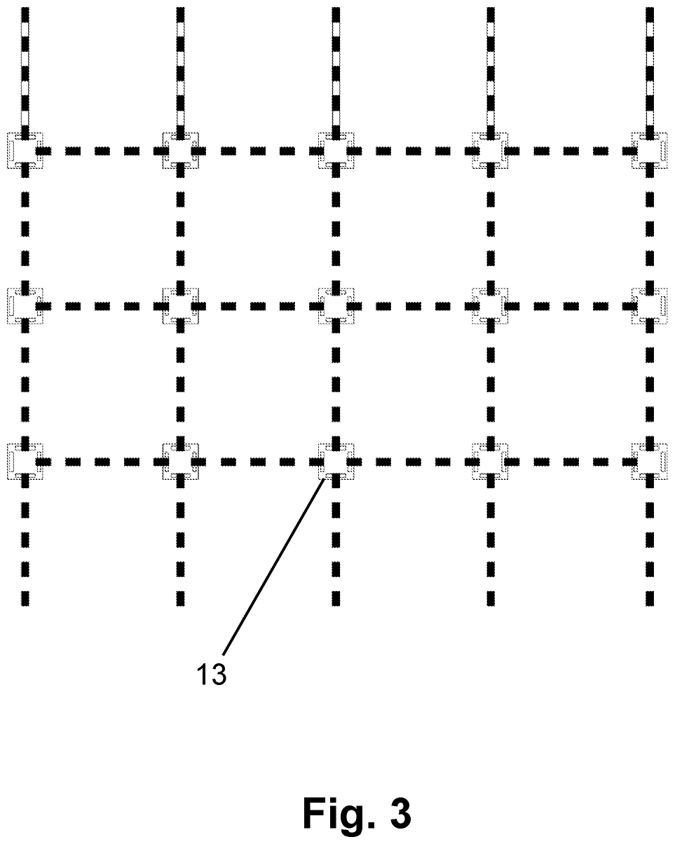

The, for example, square sensor boards (FIG. 1) are therefore preferably provided with 2 or 4 (oriented to the 4 sides), optionally with 6 connectors (one additionally facing up, one facing down):
if the sensors are used in a linear arrangement, for example to place them like a belt around the cross-section of a tree, around a church bell or around a concrete post, only two of the connectors are needed in each case (FIG. 2);
If a (possibly curved) surface, for example a flood embankment (dam), is to be examined for cavities, the sensors are connected like a two-dimensional network with preferably equidistant nodes for two-dimensional application, whereby advantageously all four lateral connectors of the sensors are then provided with cables (except for the sensors at the edge of the network, which only require 3 or 2 connections depending on their position: FIG. 3);
in the three-dimensional application for permanent monitoring of solid construction elements, the sensors should be arranged in a preferably equidistant three-dimensional grid and cast into the concrete during construction as well.

The connectors are advantageously located in the housing, which is preferably designed to be water-protected, with the electronics themselves being stored, for example by means of potting compound, in a water-proof manner and protected from vibrations in a surrounding soft material which is thus protected from vibrations.

For the permanent monitoring of a concrete construction, for example a bridge, the sensors can be linked quasi like a three-dimensional grid with tensile cable connections, hooked into the initially still empty component molds and thus “embedded” in concrete during the creation of the construction. This makes it possible not only to continuously monitor the homogeneity, stability and other structural properties of the material during and after the production of the structure, but also to detect (not only internal) aging processes and other damage as early as possible and to initiate appropriate measures—in order to prevent further damage or even accidents.

Equidistant Standard Wiring

Until now, standardized computer cables had been used in the Arbotom® sonic tomograph introduced in 1999, not only because they were inexpensive and available in different lengths, but also because they were commercially available worldwide if they needed to be replaced. Because the number of sensors was limited, mainly due to cost and installation effort, cable connections of different lengths had to be possible, for example, to be able to examine trees with wide trunk bases or large laminated beams. This was best done with standardized cables that were commercially available in the computer industry. However, these cables then had to be re-plugged for each application of the system, which costs corresponding time and reduces the durability of the cables, plugs and sockets, because the number of their plugging cycles is rather limited. In addition, when used in the field, plug-in connections also always bear the risk of being impaired or even rendered unusable by dust and dirt, or even by moisture. Finally, the tensile strength of these connectors is rather limited due to their design, because they are not intended for tensile loads.

Therefore, the new system described here has a special cable in a unit length of e.g. 25c m (which corresponds to about 10 inches and thus facilitates internationalization). This unit length thus virtually defines the maximum distance between neighbouring sensors. Thousands of applications so far have shown that the closest sensor distance is typically in the range of 20 to 30 cm.

On the one hand, the relatively short unit length of the cables enables high production quantities (thus correspondingly low manufacturing costs) and, on the other hand, inevitably leads to the fact that significantly more sensors than usual are and have to be used in order to cover the cross sections to be tested. On the tree, for example, the number of sensors is thus inevitably quadrupled because, on the one hand, sensors cannot be placed further apart from each other and, on the other hand, the entire circumference must be occupied. This improves the analysis considerably, especially with regard to the local resolution of the tomographic cross-section reconstruction, because this increases quadratically to the number of sensors.

Of course, this is only possible because the new sensors are smaller and considerably less expensive, so that the total cost of the system does not increase despite the significantly increased number of sensors.

To ensure that the electronic sensor connection cables have sufficient tensile strength on the one hand, but do not transmit any mechanical impulses (vibrations) in the longitudinal direction on the other, they are preferably designed in the form of a flat belt made of (temperature-independent) highly flexible material, for example polyurethane, with a sufficient number of electrically conductive cores that are as flexible as possible (e.g., made of stranded copper wires), known from (DE 10 2019 200 497 A1). These types of belts behave virtually like highly flexible but very tensile flat cables and can also be used at lower temperatures. They are very strong in the longitudinal direction, but very flexible in the transverse direction, thus transmitting virtually no vibrations from sensor to sensor (which is critically important for sonic tomography).

If sensors are to be integrated into concrete structures, the sensors connected with these cable straps to form a two- or three-dimensional (grid) network can be suspended in the volumes to be cast in a similar way to the steel reinforcement cages. If the sensors are then connected to the cables of equal length (i.e. equidistant) as described here, then the transmission patterns of the different types of pulses result in a matrix characteristic of the distances. This makes it easier to interpret deviations from this (characteristic) pattern as an indication of deviating properties (during manufacture or later in operation), for example cracks occurring or other damage. In the case of non-uniform distances between the sensors, which are also possible, more complex calibration measurements must be carried out, preferably at the beginning of use, in order to be able to detect structural changes more easily and more quickly later by means of reference comparison.

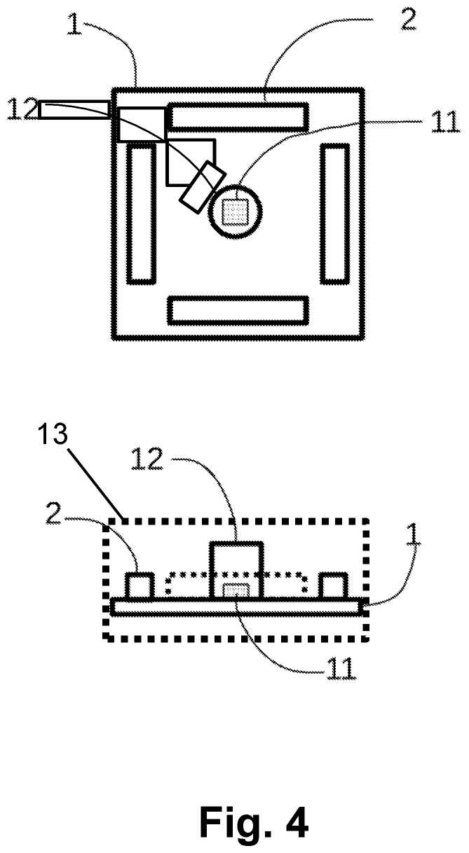

To connect the cables to the sensor boards, simple and extremely inexpensive flat ribbon connectors can be used because they are widely available, which not only provides significant cost advantages, but also represents a mechanically robust connection at the same time. Since this connector only has to be disconnected in the rare event of a defective cable, the maximum possible mating cycles of these connections do not represent any significant limitation to the service life of the system. To change the cable, the outer housing 13 is opened, which when closed automatically clamps the cable in place and thus also acts as a strain relief and protects the interior from moisture and dust, see FIG. 4.

Geometry Survey Cable Marker

In all applications, the position of the sensors must be recorded, not only because their respective distance is important for calculating and evaluating the results, but also because the position of the sensors, especially in applications on surfaces, represents the geometry and thus the shape of the test specimen that is to be recorded anyway. The accuracy requirements of the positioning depend on the respective task. For the typically examined, large old trees, a detection of the position to an accuracy of approx. 5 cm (˜2″) is usually sufficient. However, there are also applications, for example on concrete columns or on bells, where the positions should be detected to an accuracy of about 1 cm. The higher the speed of sound in a medium and the closer the spacing of the sensors, the more precisely their position must be detected.

Up to now, either an additional measuring tape has been attached to the tree or concrete column parallel to the sensor connections, or a so-called clap (=large calliper gauge) has been used. Although the tape measure is inexpensive and comparatively fast to use, it requires some practice to detect deviations from the circular shape, for example. This, on the other hand, works very well with a mechanical clamp and triangulation in the software of the measuring PC, but requires considerable additional time and expense—and has mostly proved unnecessary on old trees.

Callipers connecting by radio to the measuring mobile PC are somewhat faster to use, but much more expensive—and often result in costs that are too high for an application of the overall system. Also because of the associated costs and the sometimes considerable time required, wide potential areas of application for tomography have so far been out of reach.

To ensure that the geometric position of the sensors on the test specimen can be recorded as automatically, quickly and cost-effectively as possible, but nevertheless accurately and verifiably, the cables and sensors themselves now serve here as a measuring tape and marker by providing them with a regular color pattern with preferably maximum contrast, i.e. with a printed scale, as it were, which can subsequently be used on photos as a basis for the (automatic) recording of the geometry of the test specimen and positioning of the sensors. Since a photographic documentation of all sensors and their positioning is mandatory for all applications anyway, photos of the sensors at their respective positions must be created anyway. On the sensors themselves, for example, in addition to a (preferably running) number and optionally an e.g. two-dimensional barcode is applied or (e.g. electronically) displayed, which later then enables an automated identification of the respective sensor, its number, its distances to others and thus an automatic assignment to a position in three-dimensional space in the photos.

For example, a scale is printed on the (flat) cables between the sensors, which are preferably each of the same length, with the color changing every 5 cm (˜2″), for example, so that this is also visible from a greater distance in photos.

To simplify geometry detection, the applied pattern on the cable can additionally have corresponding line markings with a finer scale, depending on the accuracy requirements. This then also makes manual detection of sensor distances and positions during assembly quite simple. The cables are thus not only used for electrical connection (power supply, communication, exchange of analysis results) and mechanically tension-proof coupling, but at the same time also for position detection and geometry measurement of the cross sections or test specimen geometries to be examined.

Because the tomograph is often used in nature, for example on trees in the forest or park, or on supports on construction sites or in buildings, colors or color combinations are used here for the best possible automatic recognition of the sensors and the test specimen geometry, which have a particularly high contrast, e.g. black and white, or otherwise occur rather rarely (especially in nature), e.g. magenta phosphor. Using such a clearly defined brightness and color pattern, the three-dimensional detection of the positions of the sensors on the basis of smartphone photos, for example, is relatively simple and does not necessarily require a 3D camera (for the detection of three-dimensional surface structures), which are nevertheless already standard in quite a few expensive smartphones today.

This way, the positioning of the sensors then no longer requires any special work, because the position of the sensors in three-dimensional space can be determined automatically by software from the photos that have to be taken anyway for documentation. Corresponding algorithms are now even available in inexpensive software applications (APPs) on smartphones. This eliminates one of the most time-consuming work steps to date, which means a correspondingly significant time saving and at the same time makes it possible to offer tomography more accurately and yet more cost-effectively. This is because positioning is not only faster, but also more precise and reliable, because manual sources of error are eliminated.

Depending on the application, it may be necessary to select closer distances between some sensors than approximately specified by the standardized length cables described here. However, this is not a problem, because the cables do not have to be used stretched out, but should even rather only hang or lie loosely between the sensors.

Methods

In order to achieve a broader range of applications as well as the highest possible accuracy and reliability of the measurement results, fundamentally different technical processes are combined here for the first time in the same sensors, the signals are transmitted and recorded in a reproducibly defined and coordinated manner, and the data obtained are evaluated and assessed in a coordinated and combined manner:
mechanical impulses (body sound)
thermal pulses
electrical impulses (impedance/permittivity)
electromagnetic pulses

Up to now, the usual sound tomography only measured the travel time of the first signals arriving at the receiving sensor—this had many advantages compared to the ultrasonic method, which had always failed on the tree up to that point, and the otherwise usual, point-by-point measurement methods, and for the first time enabled three-dimensional sound tomography on trees and wood as well as on concrete. However, only a small part of the questions arising in practice can be answered with this method and adjacent, much larger areas of application (e.g. on solid structures, bells, facade panels and flood dams) are basically not accessible with it.

Therefore, not only are different physical measurement principles combined, but also different characteristics of the transmitted and received pulses are measured and stored in combination:
Transit time of the pulses from the respective transmitter to all other, receiving sensors as well as back to the transmitter.
Transient of the transmitted and received pulses and in particular pulse height, pulse width, pulse length, oscillation, damping and decay behavior (at the transmitting and receiving sensor) as well as the energy transfer balance (received energy compared to input-energy);

In combination and coordination, far more material properties and parameters can be recorded in this way than with the previously used technology—whereby the accuracy and resolution of the results and statements on the material condition are also significantly improved due to the now significantly higher number of support points.

However, all these parameters can only be measured and evaluated in a meaningful, sufficiently precise and, above all, reproducible manner if the pulse generation is automated and reproducible—which has also not been technically possible up to now.

Sound

The now highly developed ultrasonic sensors are mostly used in the SinglePoint process, where one sensor transmits and receives. This makes these sensors correspondingly expensive and sensitive. Nevertheless, this approach does not provide useful results in many areas due to inhomogeneities, structural disturbances, Young's modulus and density gradients as well as diffraction, refraction and boundary layer effects. Three-dimensional state tomography on wood or concrete, for example, has not yet been successful for various technical and principle reasons (including “shadowing” due to interferences and interfaces) and may remain impossible in the long term.

The best way to overcome these limitations is to significantly increase the number of simultaneously occupied “support points” (=transmitting and receiving sensors) in combination with extended detection of various pulse characteristics.

Most previous sonic tomographs, for example, used “ELEKTRET” microphones to detect the pulses (generated manually by hammer). Although these microphones are inexpensive and sufficiently precise, they can only receive signals.

In contrast, special piezo crystals are now used here, which offer decisive advantages because they . . .
7. are more cost-effective and therefore allow the production of many sensors at lower prices, thus reaching far larger market segments;
8. have no moving parts and show practically no (application-relevant) signs of aging;
9. are less sensitive to vibrations and thermal environmental changes;
10. can be easily and directly glued to a housing wall to allow the technically shortest and thus most direct connection to the test specimen (thus achieving the highest possible sensitivity and accuracy);
11. can send and receive signals (=vibrations) (one of the biggest advantages);
12. can generate signals at defined and coordinated times, in specific excitation patterns, of defined frequency, intensity and length.

In combination, these properties allow a previously unattainable high-resolution and highly sensitive sonic tomography, which for the first time is even automated, much faster and for the first time reproducible in terms of signal technology, because the pulses no longer have to be generated manually by hitting a sensor or another position (“support point”), but are always sent and received automatically in a reproducible manner by all sensors.

This brings further significant benefits and advances because, for the first time, one can
induce identical pulses at the sensors and can thus perform comparative, absolute-value-oriented, i.e. calibration-capable, investigations for material analysis, which were previously impossible in principle with the manually excited and thus inevitably different pulse intensities and shapes;
change the properties of the transmitted signals (e.g. intensity, frequency, length and pulse shape) in a defined way during the measurement on a DUT and adapt them to specific properties of the DUT and the environmental conditions (e.g. vibrations, background noise, . . . );
also change the specific properties of the transmitted signals by means of a software random generator in order to detect and characterize previously unknown properties of the test specimen and its material;
send out the transmitted signals in a defined time-delayed sequence at all or a specific selection of sensors, as required;
optionally also excite all sensors simultaneously in an identical and thus resonant manner in order to measure the “response” of the test specimen to this, which is known to allow statements to be made about specific material properties (e.g. Young's modulus);
have a tomography run automatically and repeatedly over a selected period of time or permanently, without having to repeatedly go to the test specimen itself;
measure, record and characterize the relaxation of the material at the emitting sensor after excitation of the pulses.

With the use of special piezo crystals and corresponding excitation electronics, sound tomography thus becomes much faster (a few seconds instead of several minutes per measurement), more automated (so that it can be carried out alone/independently), more accurate (even calibrated for absolute values) and more meaningful than previously conceivable—at the same time as lower costs and less effort. If necessary, the sensors can be left on the test specimen so that it can be monitored over a defined period of time or permanently, depending on the result or task, without having to go back and take action yourself.

Electrical Conductivity

The electrical conductivity is mainly determined by the concentration and mobility of charges in the material of the test specimen and thus by properties that depend in particular also on the moisture content, both in trees, woods, and in concrete and soil.

In trees, water content is also an aspect of so-called vitality, because water uptake depends on its “state of health” and on its current “biological activity” and is thus an important parameter, also in ecological as well as forestry assessments and decisions.

For this reason alone, a measured conductivity in addition to sonic tomography is valuable additional information for assessing the condition. However, fundamental limitations on the informative value of this method must also be taken into account here.

Fungal damage in trees and woods has a far greater effect on electrical conductivity than water content, because most wood-destroying fungi significantly increase conductivity. However, there are sometimes fungi that colonize wood and increase conductivity, but do not structurally degrade the wood, i.e. are statically insignificant. Thus, neither the water content nor the condition of the wood can be directly inferred from a high conductivity alone. In soil and concrete, too, the water content cannot be reliably determined by conductivity measurements alone, because the ion content there also depends on many other factors, including the salt content.

Therefore, conductivity measurement alone is neither sufficiently precise nor reliable, which is why it should only be used in combination with other methods. In combination, however, it provides important additional information, which in turn helps to close information gaps of other methods.

When using electrically conductive connecting means between the sensor and the test specimen (e.g. steel nails), the electrical conductivity measurement can be carried out with the same hardware and electronics that drive the piezo transducer, i.e. virtually without any significant additional technical equipment.

Relative (Di-electric/Capacitive) Permittivity

Wood is a dielectric and in the dry state the di-electric properties are well known, especially the correlation between the di-electric constant and the density of the wood. With an appropriate choice of measurement parameters (especially excitation frequency and voltage), the influence of the constituents present in the wood (water, tannins, fungi, . . . ) on the relative permittivity measured with it can be controlled (and their content also recorded with it).

DE000010149317A1 describes a microscopically small version of a high-frequency probe for measuring the dielectric constant of wood in order to measure tree-ring density fluctuations with high resolution. In the tomographic method described here, however, miniaturization does not have to be taken to such an extent, because only a local measurement in the area of the sensor is required, for which the already widely available components for Hf moisture measurement are integrated into the sensor electronics.

By selecting the appropriate capacitor geometry and dimensions, the penetration depth of the electric field and thus the measuring and effective range can be defined. By changing the frequency of the electric field, conclusions can be drawn, for example, about the proportion of water and other substances in the sensor. Since the double capacitor (=Hf transmitter and receiver) required for this is quite small, it can be mounted next to the sound element (piezo) without making the sensors significantly larger. Essentially the same components are required for the electrical drive and electronic control as for electrical resistance measurement. In this respect, the circuit does not become significantly larger.

Thermal Conductivity

Compared to electrical, thermal conductivity of a solid material with appreciable moisture content is more dependent on it, but hardly dependent on the local ion concentration (at and between the sensors). Therefore, the measurement of thermal pulses in trees allows a more reliable determination of the current water content than an electrical resistance measurement. So far, however, this principle of thermal conduction measurement has only been applied longitudinally to the wood fibers (vertically on the trunk) to observe the “sap flow”: the transmission of thermal pulses from a central pin to two pins located at a fixed distance above and below is measured.

In the new system described here, the transmission of thermal pulses from sensor to sensor is not measured, because the distance between them is usually too great and would require too much energy, but rather via the decrease behavior at the respective sensor: after (e.g. ohmic) excitation of a thermal pulse in the fastener (pin/nail/screw/ . . . ) on/in the test specimen, the temperature decrease in the fastener is measured. Thanks to a large number of sensors, this allows a statement to be made about the local moisture distribution and, in combination with the other measurement methods, enables more in-depth analyses and assessments than have been possible up to now; in particular, it can prevent the frequent erroneous conclusions drawn from electrical resistance measurements.

However, the decrease in temperature excitation of the lanyard after pulse-wise heating not only allows statements to be made about the local water content of the test specimen at the positions of the sensors, but also in particular about the speed of water transport in the test specimen. The faster the water flows upwards in the tree, the greater its vitality—and the faster the lanyard cools down. This thermal relaxation thus allows a relatively direct statement to be made about the state of health of the tree (especially in conjunction with the other methods described here)—and this especially over time, because the new tomograph can remain on the test specimen for hours, days or weeks if necessary due to the automated measurement and thus also record the temporal variations in the properties to be measured.

Similarly, before, during and after heating, electrical and mechanical impulses are automatically sent from the sensor-electronics to the lanyard and measured, and it is recorded how quickly sound, charge and temperature “flow off” or decrease in each case and how quickly they arrive at the other sensors. For example, the firmer or denser the material, the faster the mechanical impulses move through the test specimen. However, the higher the water content in a log, the stronger the mechanical damping of excited vibrations.

The combination of these methods allows for the first time a coordinated collection and assessment of important parameters of trees, which are of crucial importance for forestry use, for ecological and climatological research as well as for other environmental monitoring (density, elasticity modulus, . . . )—and so far either not at all, or only very laboriously and expensively could be compiled—especially not quasi-destructive as here.

Electromagnetic Continuity

In all the tomographic methods described here so far, it is basically not possible to deduce from the signals received at a sensor which path the pulses have taken through the test specimen. This limits not only the local resolution, but also the overall informative value of the method(s). Previous attempts to examine trees and wood with radar or X-ray beams have failed in practice for various reasons, some of them fundamental.

Particularly in the case of organic cross sections, the permeability for electromagnetic beams depends primarily on the density and, depending on the frequency, also on the content of water and ions (according to the respective dielectric constant). If you press your finger on a strong LED lamp, you will see in principle an image of the density distribution in the “test specimen” in the shimmering transmitted light.

Since miniaturized (directional) antennas (11) for radar, mobile radio, WIFI and other internationally permitted frequencies, especially also from the ISM bands, are now available, corresponding electronic component parts can be integrated into the new tomography sensors as required to integrate the electromagnetic transmittance of the respective test specimen into the tomographic combination analysis in a completely new way.

If the antennas, which are now available in miniaturized form, in some cases even as SMD print assemblies for circuit boards, are used, these can be designed as transmitters and receivers at low cost—especially since there are now very small but nevertheless powerful transmitters in chip form, which are used in mobile phones, among other things (and are correspondingly small and inexpensive precisely for this reason due to the high piece numbers).

Depending on the design of a preferably cylindrical shielding (12), the beam angle can then be directed, for example, to one or a few sensors preferably positioned opposite one another on the test specimen, thus achieving a beam path that can be reconstructed relatively unambiguously.

In combination with the other methods, the reconstruction of the internal state of the test specimen can be considerably improved in this way, because a direct assignment of the relevant measured values to a path through the test specimen is possible—in contrast to the other methods commonly used to date (sound, thermal and electrical pulses), in which the specific path of the pulses applied is not known in principle and cannot be calculated from the pulse itself.

If the electromagnetic pulses are emitted at the same time as, for example, the mechanical pulses, this also has the advantage that the start pulse for the sound travel time measurement can be given not necessarily via a cable, but by the electromagnetic pulse, which travels at the speed of light and therefore arrives without significant time delay (compared to stress-waves).

In combination with the other methods, the use of electromagnetic pulses improves the overall accuracy of the system, but due to the still limited number of support points, it is far from being able to provide tomography similar to CT, for example—especially since in the case of concrete columns with steel reinforcement or in the presence of other metallic components, the permeability for electromagnetic pulses is limited to non-existent anyway, but works very well in the case of organic materials.

Excitation-pulse-relaxation

In the tomographic methods established so far, signals are usually sent from a transmitter to one or many receivers. In this case, the decreasing and resonant behavior of the excited (mechanical, thermal and electrical) pulses are also recorded, which, especially in combination, enables extended analyses and statements on the material under investigation, but only provides relevant additional information if as many transmitting sensors as possible are used or positions are occupied in order to achieve a sufficient local resolution.

For this reason, too, the sensors are preferably connected to the material to be tested via a good current- and heat-conducting, preferably metallic connecting means (depending on the application, nails, pins, screws, adapter plates). This connecting means can be excited mechanically, thermally and/or electrically in pulses for a defined time and in a defined manner. Before, during and after this excitation, the corresponding physical measured variables (mechanical, thermal or electrical) are continuously monitored and recorded. In this way, for example, all sensors can excite pulses of different frequencies in the same and coordinated manner in order to record the material's behavior, which may be resonant depending on the frequency.

The local (mechanical) vibration properties, for example, allow a statement to be made about local elastic moduli, the thermal ones about the local moisture content, and the electrical ones about the ion content. The faster the signals (=excitations) “flow off”, the greater the corresponding local properties of the test specimen, whereby these properties can be determined even better and more precisely by means of systematic changes in excitation frequency, intensity and length.

Those physical measurement procedures that do not interfere with each other can be performed simultaneously or slightly offset to save time.

Embodiments of the present invention may have the following aspects alternatively or in any combination:

Methods and devices for multidimensional tomographic material and condition testing, for example on trees, timbers, bells, soil or concrete, can be specified.

Mechanical, electrical, di-electrical, thermal and/or electromagnetic pulses or signals can be transmitted, received and/or recorded in a combined and/or time-coordinated manner.

All (i.e. also the mechanical) pulses in all sensors can be generated automatically in a defined manner and thus reproducibly identical, in order to enable comparable and, for the first time, absolute value-calibrated analyses.

The height, shape, intensity, frequency/waveform and/or time length of the emitted pulses can be changed, for example, in the course of a measurement, preferably automatically, in order to adapt them, for example, to boundary conditions (interference signals) and/or material properties of the test specimen and/or depending on the results obtained in each case, and thus, for example, to increase the validity of the analysis.

After the excitation of pulses, the relaxation at the transmitting sensor or the connecting means to the test specimen can be measured and/or recorded.

The pulses can be excited and/or transmitted with a time overlap or time delay such that the total time required for the measurement is minimized.

In particular, the mechanical signals can also be emitted simultaneously and, if necessary, in a resonant manner, for example to better characterize the corresponding material properties.

The signals can be generated, transmitted, received, stored and/or analyzed automatically by the sensors themselves without human intervention or activity.

Electromagnetic pulses can be radiated at a specified angle by means of a directional antenna miniaturized by construction, so that for the first time a defined pulse path through the test object is achieved.

The arrival of the electromagnetic pulses can be used as a start signal for the other pulses, especially the mechanical ones.

A display can be implemented on the sensors, the number and/or position of which is displayed as a number and/or letter code and/or also as a barcode.

The sensors can be equidistantly connected with a preferably equal-length and/or tensile-strength but otherwise soft-flexible flat ribbon cable (“flat belt”), which enables both a mechanical and an electrical connection.

The connecting cables, which are preferably designed as ribbon cables, can be marked to enable automatic, preferably optical, measurement of the test specimen, its geometry and/or the sensor positions, for example from photographs.

The boards can be provided with preferably 4, optionally also 6, connecting elements for connecting the connecting cables, so that a one-, two- or three-dimensional and/or grid-shaped arrangement is possible.

1-15. (canceled)

16. Method for the multidimensional, tomographic testing of materials and/or conditions on a test specimen, wherein a sensor with an electronic system for recording and processing measurement data is arranged on the test specimen or in a region of the test specimen at a plurality of predeterminable positions, wherein at least one sensor or the electronic system of at least one sensor is used to carry out a plurality of different physical measurement methods on the test specimen and to generate, trigger and/or emit pulses and/or signals required for carrying out at least one of the measurement methods.

17. Method according to claim 16, wherein the pulses or signals comprise one or more of mechanical, electrical, di-electrical, thermal or electromagnetical pulses or signals, wherein mechanical pulses or signals can be generated by means of a piezo crystal.

18. Method according to claim 16, wherein the pulses or signals or a selection of similar or different pulses or signals is or are generated, triggered, emitted, received and/or recorded by the sensor or sensors or the electronics in a combined, simultaneous and/or temporally coordinated manner.

19. Method according to claim 16, wherein the pulses or signals or a selection of similar or different pulses or signals are generated automatically in at least one sensor—in a defined manner or by random generator—and/or that the pulses or signals are one or more of excited, generated, triggered, transmitted, received, stored or analyzed automatically and thus without human influence or activity by the sensors or the electronics of the sensors themselves.

20. Method according to claim 16, wherein the level, shape, intensity, frequency/waveform and/or time length of the pulses or signals transmitted from is or are adaptively changed in order—with a view to increasing the informative value of the method—to carry out an adaptation to boundary conditions, interference signals and/or material properties of the test specimen and/or to measurement data already recorded or measurement results achieved.

21. Method according to claim 20, wherein the adaptation is carried out adaptively in the course of a measurement and/or automatically.

22. Method according to claim 16, wherein after excitation, generation, triggering and/or emission of one or more pulses or signals by a sensor or electronics of the sensor, a relaxation at this sensor, at these electronics and/or at a connecting means to the test specimen is measured and/or recorded.

23. Method according to claim 16, wherein the pulses or signals are excited, generated, triggered and/or emitted in a temporally overlapping or time-delayed manner in such a way that the total time required for the test or a measurement is minimized, or that mechanical pulses or signals are emitted simultaneously or in a resonant manner in order, for example, to be able to better characterize corresponding material properties.

24. Method according to claim 16, wherein at least one of:
electromagnetic pulses or signals are radiated by means of a directional antenna at a predetermined angle so that a defined pulse-signal path is achieved through the test specimen; or
an arrival of, in particular, electromagnetic pulses is used as a start signal for the start of pulses or signals from at least one other sensor.

25. Method according to claim 24, wherein the directional antenna is miniaturized in terms of construction and the pulses are further the mechanical pulses or signals.

26. Method according to claim 16, wherein a display is realized at the sensors, the number and/or position of which is displayed as a number and/or letter code and/or as a code or barcode and/or in that the sensors are connected to a coupling means which enables both a mechanical and an electrical connection.

27. Method according to claim 26, wherein the coupling means is a flat ribbon cable or a flat belt.

28. Method according to claim 26, wherein the coupling means for equidistant connection of the sensors is realized in the form of coupling elements of equal length and/or tensile strength and/or soft flexibility.

29. Method according to claim 26, wherein the coupling means or the coupling elements enable an automatic, measurement of the test specimen, its geometry and/or the sensor positions, for example by means of a photograph.

30. Method according to claim 29, wherein the automatic measurement is an optical measurement.

31. Method according to claim 26, wherein the sensors or boards of the sensors are provided with a set of connecting elements for connecting the coupling means or coupling elements in such a way that a one-, two- or three-dimensional and/or grid-shaped coupled arrangement of the sensors is possible.

32. Method according to claim 31, wherein the set of connecting elements comprise four or six connecting elements.

33. Device for multidimensional, tomographic material and/or status testing on a test specimen, in particular for carrying out a method according to claim 16, having a plurality of sensors each having electronics, it being possible to arrange on the test specimen or in a region of the test specimen at a plurality of predeterminable positions in each case a sensor having electronics for recording and processing measurement data, at least one sensor or the electronics of at least one sensor being designed for carrying out a plurality of different physical measurement methods on the test specimen and for generating, triggering and/or transmitting pulses and/or signals required for carrying out at least one of the measurement methods.

34. Sensor of the device according to claim 33.
